(19) United States
(12) Patent Application Publication
(10) Pub. No.: US 2024/0212473 A1
(43) Pub. Date: Jun. 27, 2024

(54) TEMPERATURE ALERT DEVICE FOR A CHILD OR A PET IN A VEHICLE

(71) Applicants: Steven Landas, Riverside, CA (US); David L. MacArthur, Riverside, CA (US)

(72) Inventors: Steven Landas, Riverside, CA (US); David L. MacArthur, Riverside, CA (US)

(21) Appl. No.: 18/087,430

(22) Filed: Dec. 22, 2022

(51) Int. Cl. G08B 21/02

(52) U.S. Cl. CPC G08B 21/0269; G08B 21/0211

(57) ABSTRACT

A temperature alert device for transmitting an alert signal when an ambient temperature within a vehicle becomes dangerously high for a child or a pet includes a housing containing a control circuit with a timer, a temperature sensor, and a transceiver. The temperature sensor is configured for detecting an ambient air temperature, and the transceiver is configured for transmitting an alert signal to one of a portable remote device and an emergency dispatch system when the ambient temperature exceeds a threshold temperature for a threshold time period. An attachment member is coupled to the outer wall of the housing and is configured for facilitating attachment of the housing to one of a seatbelt, an article of clothing, and a leash. A method of determining the ambient temperature and transmitting alert signals is also disclosed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to temperature alert devices and more particularly pertains to a new temperature alert device for transmitting an alert signal when an ambient temperature within a vehicle becomes dangerously high for a child or a pet.

### (2) Description of Related Art including information disclosed under 37 CFR 1.97 and 1.98

The prior art relates to temperature alert devices such as a car seat with a temperature alert system which transmits an alert to a mobile device alerting that the car seat detects an unsafe temperature. The prior art also discloses a vehicle occupant detection and alert system which detects the presence of an occupant in a parked vehicle and the temperature inside the vehicle. There are several devices in the prior art which disclose a system for sending an alert to a remote electronic device of an unsafe temperature within a vehicle.

### BRIEF SUMMARY OF THE INVENTION

An embodiment of the disclosure meets the needs presented above by generally comprising a housing with an outer wall and an interior space bounded by the outer wall. The outer wall includes a front wall, a back wall, and a perimeter wall extending between the front wall and the back wall. A control circuit including a timer is coupled to the housing and is positioned within the interior space. A temperature sensor is electrically coupled to the control circuit and is positioned within the interior space. The temperature sensor is configured for detecting an ambient air temperature. A transceiver is electrically coupled to the control circuit and is positioned within the interior space. The transceiver is configured for transmitting an alert signal to one of a portable remote device and an emergency dispatch system when the ambient air temperature exceeds a threshold temperature for at least a threshold time period. An attachment member is coupled to the outer wall of the housing and is configured for facilitating attachment of the housing to one of a seatbelt, an article of clothing, and a leash.

Another embodiment of the disclosure comprises a method of keeping a child or a pet safe from dangerously high temperatures within a vehicle comprising positioning a temperature alert device in the vehicle and detecting a temperature of a quantity of air within the vehicle. The method also comprises actuating a temperature control unit of the vehicle to cool the quantity of air when the temperature exceeds a first threshold temperature for a first threshold time period. An alert signal is transmitted to a portable remote device when the temperature exceeds a second threshold temperature for a second threshold time period, the second threshold temperature being greater than the first threshold temperature. The geographical position of the temperature alert device is determined, and an alarm signal is transmitted to an emergency dispatch system when the temperature exceeds a third threshold temperature for a third threshold time period. The third threshold temperature is greater than the second threshold temperature. The alarm signal includes the geographical position and a message indicating the child or the pet is exposed to dangerously high temperatures.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a temperature alert device according to an embodiment of the disclosure.

FIG. 2 is a top rear side perspective view of an embodiment of the disclosure.

FIG. 3 is an exploded top rear side perspective view of an embodiment of the disclosure.

FIG. 4 is a rear view of an embodiment of the disclosure.

FIG. 5 is a cross-sectional view of an embodiment of the disclosure from Arrows 5-5 in FIG. 4.

FIG. 6 is an in-use view of an embodiment of the disclosure.

FIG. 7 is a block diagram of an embodiment of the disclosure.

### DETAILED DESCRIPTION OF THE INVENTION

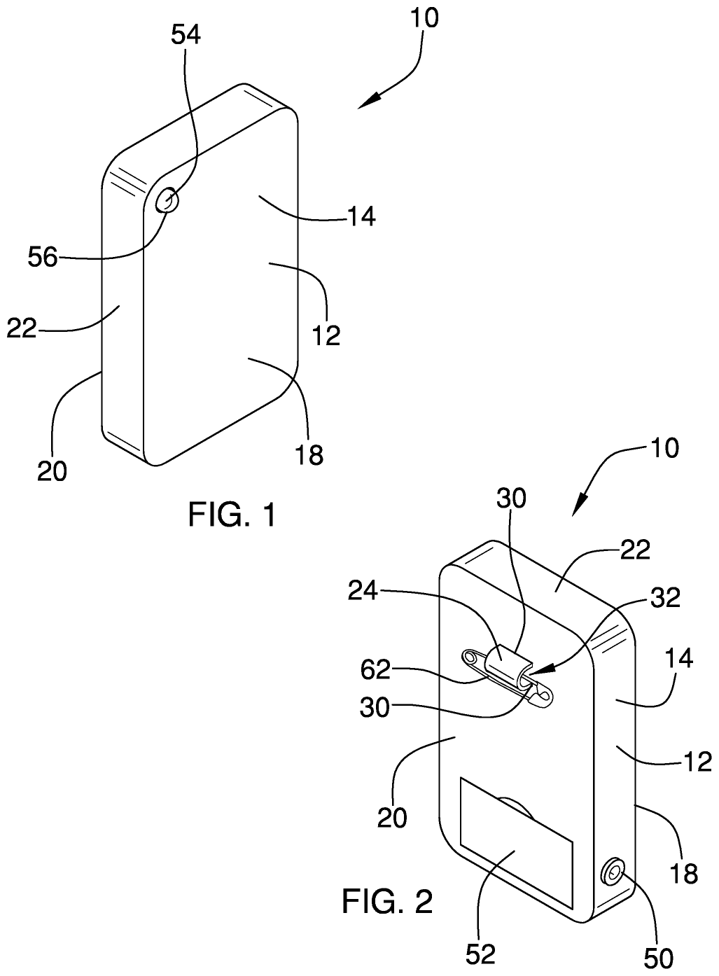

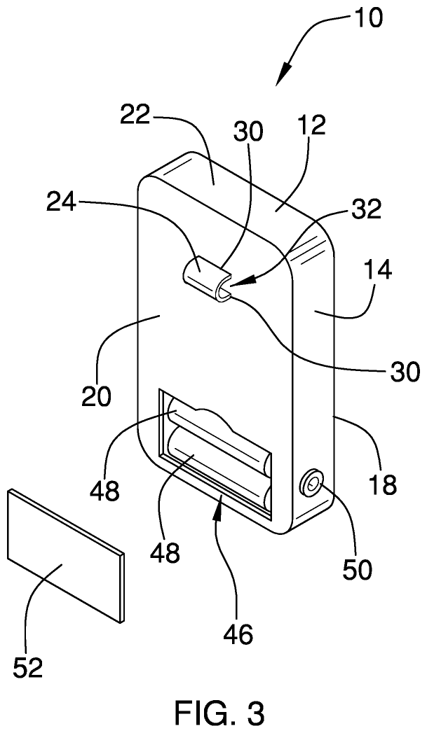

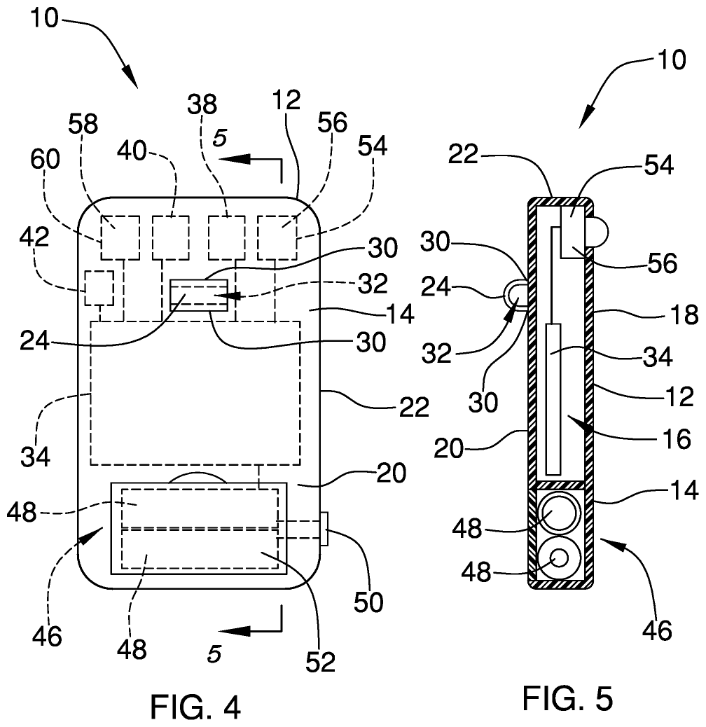

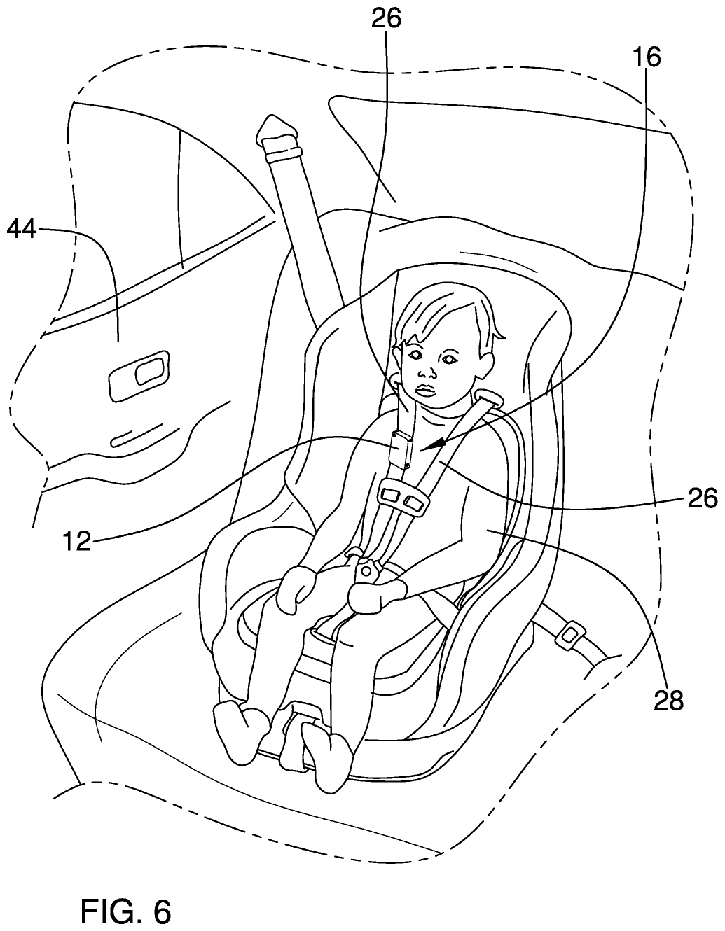

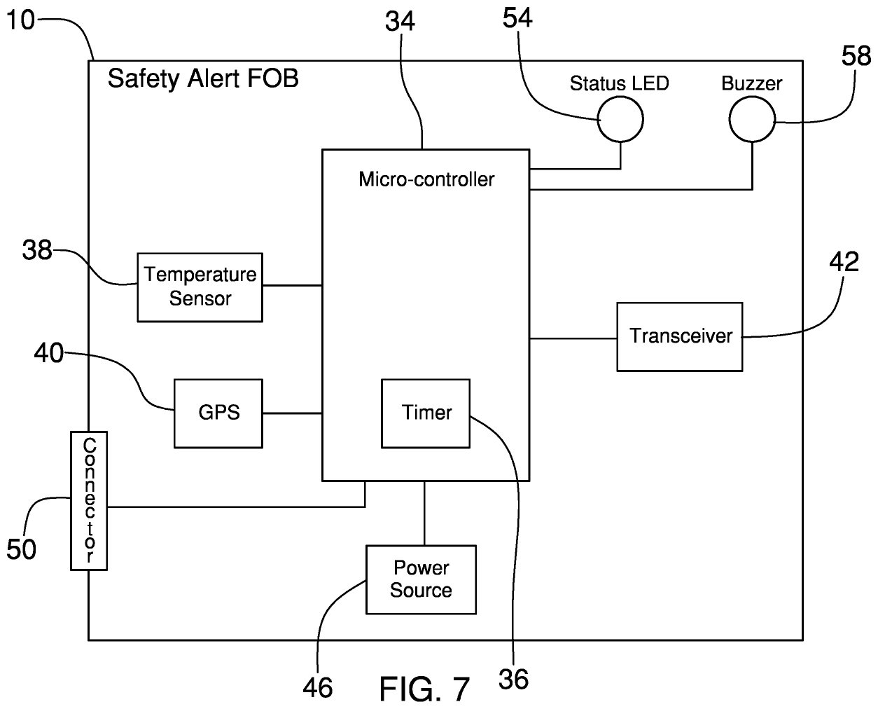

With reference now to the drawings, and in particular to FIGS. 1 through 7 thereof, a new temperature alert device embodying the principles and concepts of an embodiment of the disclosure and generally designated by the reference numeral 10 will be described.

As best illustrated in FIGS. 1 through 7, the temperature alert device 10 generally comprises a housing 12 with an outer wall 14 and an interior space 16 bounded by the outer wall 14. The outer wall 14 includes a front wall 18, a back wall 20, and a perimeter wall 22 extending between the front wall 18 and the back wall 20. An attachment member 24 is coupled to the outer wall 14 of the housing 12 and is configured for facilitating attachment of the housing 12 to one of a seatbelt 26, an article of clothing 28, and a leash. The attachment member 24 may comprise a clip, key ring, hook-and-loop fastener, or the like. In one embodiment, the attachment member 24 is positioned on the back wall 20. The attachment member 24 in the one embodiment has a pair of ends 30, each of which is coupled to the housing 12. The attachment member 24 and the housing 12 define a channel 32 which is configured for receiving an object to attach the housing 12 to one of the seatbelt 26, the article of clothing 28, and the leash.

For example, a safety pin 62 may be received through the channel 32 and attached to the article of clothing 28. Or a string, shoelace, or the like may be inserted through the channel 32 and tied to the leash.

A control circuit 34 including a timer 36 is coupled to the housing 12 and is positioned within the interior space 16. A temperature sensor 38 is electrically coupled to the control circuit 34 and is positioned within the interior space 16. The temperature sensor 38 is configured for detecting an ambient air temperature. A global positioning system (GPS) module 40 is electrically coupled to the control circuit 34 and is positioned within the interior space 16. The GPS module 40 is configured for determining a geographical position of the temperature alert device 10.

The transceiver 42 is electrically coupled to the control circuit 34 and is positioned within the interior space 16. The transceiver 42 may be configured for transmitting a temperature control signal to a vehicle 44 to cool the vehicle 44 when the ambient air temperature exceeds a first threshold temperature for at least a first threshold time period. The transceiver 42 is configured for transmitting an alert signal to one of a portable remote device and an emergency dispatch system when the ambient air temperature exceeds a second threshold temperature for at least a second threshold time period. The alert signal may include the geographical position. In some embodiments, the transceiver 42 is configured for transmitting the alert signal to the portable remote device and is configured for transmitting a separate alarm signal to the emergency dispatch system when the ambient air temperature exceeds a third threshold temperature for at least a third threshold time period. In such embodiments, the alarm signal includes the geographical position and a message indicating a child or a pet is exposed to dangerously high temperatures.

The first, second, and third threshold temperatures and the first, second, and third threshold time periods may each be selectable by a user or may each be programmed during manufacture of the temperature alert device 10. In some embodiments, the second threshold temperature is greater than the first threshold temperature, and the third threshold temperature is greater than the second temperature. The first, second, and third time periods may be equal to each other and may also be set to ensure that the temperature alert device 10 does not perform an action due to a momentary increase in the ambient temperature and an isolated errant reading of the ambient temperature.

In an example embodiment, the first, second, and third time periods are set to between 1.0 and 10.0 minutes. The first threshold temperature is set to between 75.0 and 90.0 degrees Fahrenheit, the second threshold temperature is set to between 90.0 and 100.0 degrees Fahrenheit, and the third threshold temperature is set to 100.0 degrees Fahrenheit or above. In this example embodiment, the vehicle 44 is activated to cool the vehicle 44 when the ambient temperature rises above the first threshold temperature for the first threshold time period. If the vehicle 44 does not adequately cool itself, and the ambient temperature exceeds the second threshold temperature for the second threshold time period, the remote portable device is notified. If the ambient temperature continues to rise and reaches beyond the third threshold temperature for the third threshold time period, the emergency dispatch system is contacted so that emergency personnel are called to the dangerous situation to attend to the child or the pet.

The portable remote device may be a dedicated device manufactured for the purpose of use with the temperature alert device 10, or the portable remote device may be a mobile phone, a tablet, a smart watch, or the like. In some embodiments, the portable remote device has an input such that a user can control the temperature alert device 10. For example, the input may be actuated to select the first, second, and third threshold temperatures and the first, second, and third threshold time periods. The input may also be actuated to turn the temperature alert device 10 on and off.

A power source 46 is electrically coupled to the control circuit 34 and is positioned within the interior space 16. The power source 46 may comprise at least one battery 48. A charging port 50 may be electrically coupled to the control circuit 34 for charging the at least one battery 48. The charging port 50 is coupled to the outer wall 14 of the housing 12 and is positioned on the perimeter wall 22. A door 52 is coupled to the outer wall 14 and positioned on the back wall 20 for accessing the power source 46.

A status indicator 54 is electrically coupled to the control circuit 34 for indicating when the temperature alert device 10 is turned on. The status indicator 54 comprises a light emitter 56 and is configured for emitting a light signal to indicate the temperature alert device 10 is turned on. The status indicator 54 is coupled to the housing 12 and is positioned on the front wall 18, the light emitter 56 is. A low-power indicator 58 may also be electrically coupled to the control circuit 34 for indicating when the at least one battery 48 has a low charge. The charge level corresponding to the low charge may be determined during manufacture and may be defined as a charge level that will be able to power the temperature alert device 10 for less than one hour. The low-power indicator 58 may be a sound emitter 60 which is configured to emit a sound when the at least one battery 48 has the low charge.

In use, the temperature alert device 10 is positioned in the vehicle 44 and may be attached to an article of clothing 28 being worn by the child, a leash worn by the pet, or the like. If a user leaves the child or the pet in the vehicle 44, the temperature alert device 10 will progress through different operations as the ambient temperature within the vehicle 44 rises to unsafe levels for the child or the pet. When the temperature sensor 38 detects that the ambient temperature exceeds the first threshold temperature for at least the first threshold time period, the transceiver 42 transmits the temperature control signal to the vehicle 44 to cool the vehicle 44. If the temperature reaches beyond the second threshold temperature for at least the second threshold time period, the alert signal is transmitted to one of the portable remote device and the emergency dispatch system. In embodiments configured for it, the transceiver 42 transmits the alarm signal to the emergency dispatch system when the temperature sensor 38 detects that the ambient temperature has exceeded the third threshold temperature for at least the third threshold time period.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A temperature alert device for a child or a pet in a vehicle, the temperature alert device comprising:
a housing having an outer wall, the housing having an interior space being bounded by the outer wall, the outer wall including a front wall, a back wall, and a perimeter wall extending between the front wall and the back wall;
a control circuit being coupled to the housing, the control circuit being positioned within the interior space, the control circuit including a timer;
a temperature sensor being electrically coupled to the control circuit, the temperature sensor being positioned within the interior space, the temperature sensor being configured for detecting an ambient air temperature;
a transceiver being electrically coupled to the control circuit, the transceiver being positioned within the interior space, the transceiver being configured for transmitting an alert signal to one of a portable remote device and an emergency dispatch system when the ambient air temperature exceeds a threshold temperature for at least a threshold time period; and
an attachment member being coupled to the outer wall of the housing, the attachment member being configured for facilitating attachment of the housing to one of a seatbelt, an article of clothing, and a leash, the attachment member being positioned on the back wall, the attachment member having a pair of ends, each of the pair of ends being coupled to the housing, the attachment member and the housing defining a channel therebetween, the channel being configured for receiving an object therebetween to attach the housing to the one of the seatbelt, the article of clothing, and the leash, the opposed ends being attached to a rear face of the outer wall perpendicular to longitudinal sides of the outer wall wherein the channel is perpendicular to the longitudinal sides of the outer wall, the opposing ends being centered between the longitudinal sides of the outer wall, the attachment member having a length between the opposed ends such that an entirety of the attachment member is positioned inset from a peripheral edge of said outer wall.

2. (canceled)

3. The device of claim 1, wherein the threshold temperature defines a second threshold temperature and the threshold time period defines a second threshold time period, the transceiver being configured for transmitting a temperature control signal to the vehicle to cool the vehicle when the ambient air temperature exceeds a first threshold temperature for at least a first threshold time period.

4. The device of claim 1, further comprising a global positioning system (GPS) module being electrically coupled to the control circuit, the GPS module being positioned within the interior space, the GPS module being configured for determining a geographical position of the temperature alert device, the alert signal including the geographical position.

5. The device of claim 1, further comprising a power source being electrically coupled to the control circuit, the power source being positioned within the interior space.

6. The device of claim 5, wherein the power source comprises at least one battery.

7. The device of claim 6, further comprising a charging port being electrically coupled to the control circuit for charging the at least one battery, the charging port being coupled to the outer wall of the housing, the charging port being positioned on the perimeter wall.

8. The device of claim 5, further comprising a door being coupled to the outer wall for accessing the power source, the door being positioned on the back wall.

9. The device of claim 1, further comprising a status indicator being electrically coupled to the control circuit for indicating when the temperature alert device is turned on, the status indicator comprising a light emitter, the light emitter being coupled to the housing and being positioned on the front wall, the light emitter being configured for emitting a light signal to indicate the temperature alert device is turned on.

10. A temperature alert device for a child or a pet in a vehicle, the temperature alert device comprising:
a housing having an outer wall, the housing having an interior space being bounded by the outer wall, the outer wall including a front wall, a back wall, and a perimeter wall extending between the front wall and the back wall;
a control circuit being coupled to the housing, the control circuit being positioned within the interior space, the control circuit including a timer;
a temperature sensor being electrically coupled to the control circuit, the temperature sensor being positioned within the interior space, the temperature sensor being configured for detecting an ambient air temperature;
a global positioning system (GPS) module being electrically coupled to the control circuit, the GPS module being positioned within the interior space, the GPS module being configured for determining a geographical position of the temperature alert device;
a transceiver being electrically coupled to the control circuit, the transceiver being positioned within the interior space, the transceiver being configured for transmitting an alert signal to one of a portable remote device and an emergency dispatch system when the ambient air temperature exceeds a first threshold temperature for at least a first threshold time period, the alert signal including the geographical position, the transceiver being configured for transmitting a temperature control signal to the vehicle to cool the vehicle when the ambient air temperature exceeds a second threshold temperature for at least a second threshold time period;
a power source being electrically coupled to the control circuit, the power source being positioned within the interior space, the power source comprising at least one battery;
a door being coupled to the outer wall for accessing the power source, the door being positioned on the back wall;
a charging port being electrically coupled to the control circuit for charging the at least one battery, the charging port being coupled to the outer wall of the housing, the charging port being positioned on the perimeter wall;
a status indicator being electrically coupled to the control circuit for indicating when the temperature alert device is turned on, the status indicator comprising a light emitter, the light emitter being coupled to the housing and being positioned on the front wall, the light emitter being configured for emitting a light signal to indicate the temperature alert device is turned on; and
an attachment member being coupled to the outer wall of the housing, the attachment member being configured for facilitating attachment of the housing to one of a seatbelt, an article of clothing, and a leash, the attachment member being positioned on the back wall, the attachment member having a pair of ends, each of the pair of ends being coupled to the housing, the attachment member and the housing defining a channel therebetween, the channel being configured for receiving an object therebetween to attach the housing to one of the seatbelt, the article of clothing, and the leash, the opposed ends being attached to a rear face of the outer wall perpendicular to longitudinal sides of the outer wall wherein the channel is perpendicular to the longitudinal sides of the outer wall, the opposing ends being centered between the longitudinal sides of the outer wall, the attachment member having a length between the opposed ends such that an entirety of the attachment member is positioned inset from a peripheral edge of said outer wall.

11. (canceled)
